(19) United States
(12) Patent Application Publication
(10) Pub. No.: US 2017/0359962 A1
(43) Pub. Date: Dec. 21, 2017

(54) Electric pruning scissors

(71) Applicant: Xianpeng MA, Xiamen City, Fujian Province (CN)

(72) Inventor: Xianpeng MA, Xiamen City, Fujian Province (CN)

(21) Appl. No.: 15/542,885

(22) PCT Filed: Apr. 29, 2015
(86) PCT No.: PCT/CN2015/077870

§ 371 Date: Jul. 11, 2017

(30) Foreign Application Priority Data
Feb. 12, 2015 (CN) 201510072074.0

(51) Int. Cl. A01G 3/037

(52) U.S. Cl. CPC A01G 3/037

(57) ABSTRACT

The invention discloses electric pruning scissors comprising a shear body, wherein a movable blade and a fixed blade are arranged at a front end of the shear body, and a tail end of the shear body is connected with a housing; the housing is internally provided with a driving device; a trigger is arranged at the bottom of the housing; and the driving device comprises a motor, an epicyclic gearbox, a gear set and a power supply module. The electric pruning scissors of the invention are characterized by high energy transmission, low noise, easily replaceable blades and a long service life.

### FIELD OF THE INVENTION

The invention relates to the field of garden pruning equipment, and particularly to electric pruning scissors.

### BACKGROUND OF THE INVENTION

Pruning scissors are tools commonly used for pruning a variety of shrubs and branches in garden. During use, a blade edge is easily worn and therefore a blade needs to be frequently replaced, but the whole housing needs to be disassembled during replacement, which is relatively cumbersome, time-consuming and labor-intensive. Since electric pruning scissors need high energy, its driving device produces louder noise during transmission, and such scissors are easily worn due to high energy consumption.

### SUMMARY OF THE INVENTION

An object of an embodiment of the invention is to provide electric pruning scissors which are characterized by high energy transmission, low noise, easily replaceable blades and a long service life.

Electric pruning scissors provided by an embodiment of the invention comprises a shear body, wherein a movable blade and a fixed blade in movable connection are arranged at a front end of the shear body; a tail end of the shear body is connected with a housing; the housing is internally provided with a driving device for driving the movable blade to operate; a trigger is arranged at the bottom of the housing; the driving device comprises a motor, an epicyclic gearbox, a screw, a bearing and a power supply; one end of the motor is electrically connected with the power supply and the other end of the motor drives the epicyclic gearbox; one end of the epicyclic gearbox is connected with the bearing by a bearing fixing ring; one end of the bearing is connected with the screw; one end of the screw is connected with a guide tube by a feed screw nut; the guide tube is externally sleeved with a casting; and one end of the casting that is close to the movable blade is connected with a guide rod.

Optionally, the epicyclic gearbox comprises a motor gear, a planetary gear, an internal gear ring, a gear carrier and a gear ring sleeve; a spacer is arranged between the motor gear and the planetary gear; the planetary gear is fixed on a raised cylinder of the gear carrier and clamped into the internal gear ring; and the internal gear ring is located in the gear ring sleeve and the bearing fixing ring is arranged at an end of the gear ring sleeve.

Optionally, the housing comprises a left side body and a right side body; and the left side body and the right side body are buckled together to form a hollow sealed whole body, a front end of which is provided with openings where the movable blade and the fixed blade are mounted.

Optionally, a trigger is arranged at the bottom of the housing; the trigger is connected with a circuit switchboard; and the circuit switchboard is connected with a circuit board for controlling an on-off state of the power supply and the rotation direction of the epicyclic gearbox by a magnet.

Optionally, the housing is also internally provided with an overload protection chip.

Optionally, joints between the housing and the movable blade and between the housing and the fixed blade are respectively provided with a silica gel dust-proof pad.

It can be seen from the above that the electric pruning scissors have the advantages of high energy transmission, low noise, low energy consumption and wear resistance by using a unique driving device with an epicyclic gearbox as a core part in a technical solution of an embodiment of the invention. Meanwhile, the design of a detachable housing allows easier replacement of blades; and the design of an inductive trigger, i.e. a non-contact switch, eliminates the consideration for mechanical life and electrical life during operation, thus finally prolonging the service life of the electric pruning scissors.

### BRIEF DESCRIPTION OF THE DRAWINGS

The accompanying drawings illustrated herein are used to provide a further understanding of the invention and constitute a part of the present application, but do not unduly limit the invention, in which:

FIG. 1 is a schematic structural view of electric pruning scissors provided by an embodiment of the invention; and

FIG. 2 is an exploded structural view of electric pruning scissors provided by an embodiment of the invention.

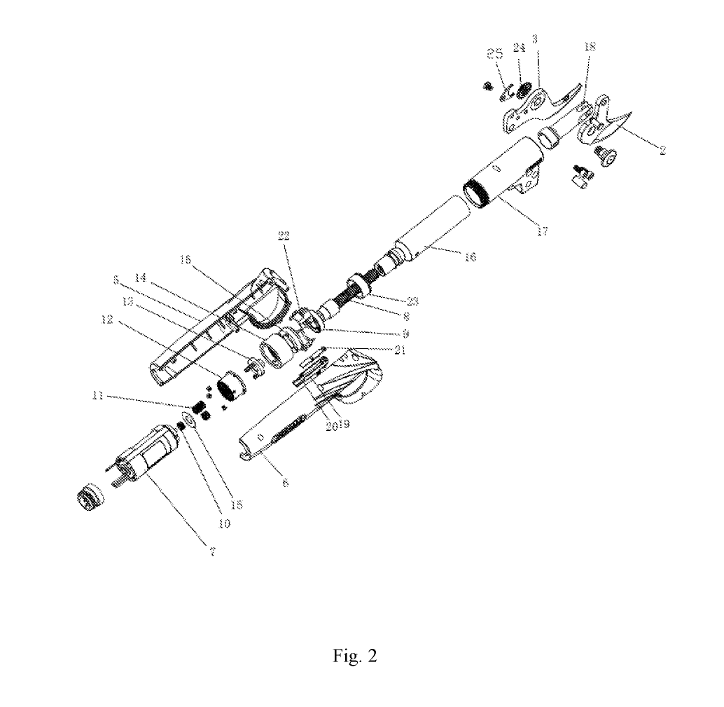

### DETAILED DESCRIPTION OF THE INVENTION

The invention will be described below in detail with reference to the accompanying drawings and particular embodiments. Herein, illustrative embodiments and illustrations of the invention are used for explaining the invention, but do not limit the invention.

### Embodiment

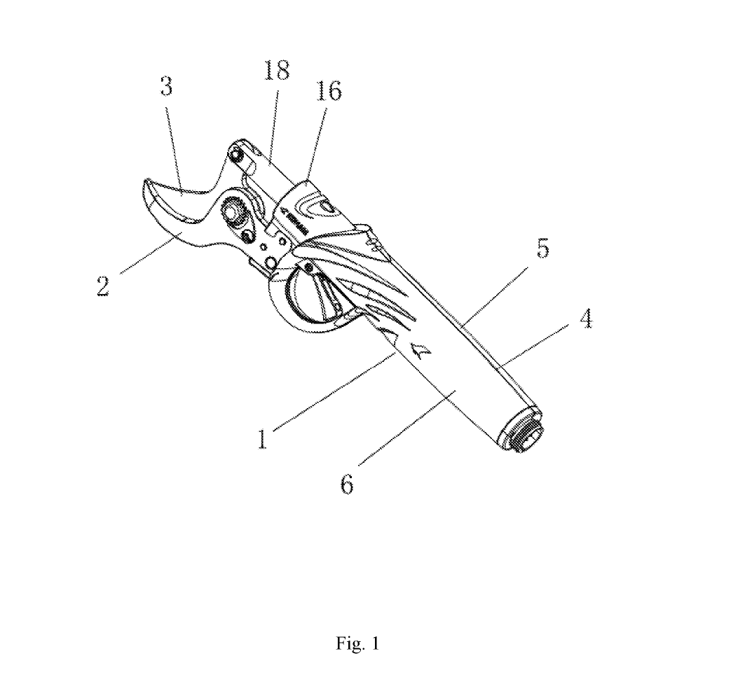

As shown in FIG. 1, the electric pruning scissors of the invention comprises a shear body 1, wherein a movable blade 2 and a fixed blade 3 in movable connection are arranged at a front end of the shear body 1, and the movable blade 1 and the fixed blade 3 are shown in movable connection via a pin bolt; a tail end of the shear body 1 is connected with a housing 4; the housing 4 consists of two parts: a left side body 5 and a right side body 6; and the left side body 5 and the right side body 6 are buckled together in a left-right manner and form a hollow sealed whole body, a front end of which is provided with openings where the movable blade 2 and the fixed blade 3 are mounted, and such design is aimed to conveniently replace the movable blade 2 or the fixed blade 3.

The housing 4 is internally provided with a driving device for driving the movable blade 2 to operate; the driving device comprises a motor 7, an epicyclic gearbox, a screw 8, a bearing 9 and a power supply; one end of the motor 7 is electrically connected with the power supply and the other end of the motor drives the epicyclic gearbox; one end of the epicyclic gearbox is connected with the bearing 9 by a bearing fixing ring 15; and one end of the bearing 9 is connected with the screw 8. The epicyclic gearbox comprises a motor gear 10, a planetary gear 11, an internal gear ring 12, a gear carrier 13 and a gear ring sleeve 14; a spacer 15 is arranged between the motor gear 10 and the planetary gear 11; the planetary gear 11 is fixed on a raised cylinder of the gear carrier 13 and clamped into the internal gear ring 12; and the internal gear ring 12 is located in the gear ring sleeve 14 and an end of the gear ring sleeve 14 is connected with the bearing fixing ring 15. One end of the screw 8 is connected with a guide tube 16 by a feed screw nut; the guide tube 16 is externally sleeved with a casting 17; and one end of the casting 17 is connected with a guide rod 18. The guide rod 18 is movably connected with the movable blade 2 via a guide rod pin bolt and a blade pin bolt, and fixedly connected with the fixed blade 3 via a collar screw, a collar 25 and a gear nut 24. The motor 8 is a brushless motor.

During operation, the motor 7 rotates to drive the epicyclic gearbox to rotate, then the rotating epicyclic gearbox drives the bearing 9 to rotate, the rotating bearing 9 drives the screw 8 to rotate, and the rotating screw 8 drives the guide rod 18 to rotate, thus finally driving the movable blade 2 to operate.

A trigger 19 is arranged at the bottom of the housing 4; the trigger 19 is connected with a circuit switchboard 20; the circuit switchboard 20 is connected with a circuit board 21 by a magnet 22; and the circuit board 21 is used for controlling an on-off state of the power supply and the rotation direction of the epicyclic gearbox.

The housing 4 is also internally provided with an overload protection chip for controlling the disconnection of the power supply, thus avoiding burnout due to short circuit.

Joints between the housing 4 and the movable blade 2 and between the housing 4 and the fixed blade 3 are respectively provided with a silica gel dust-proof pad 23. The pad acts to prevent parts and components from being damaged due to pruned branch shavings entering the housing 4 during operation.

A technical solution provided by an embodiment of the invention has been introduced above in detail, the principles and implementations of an embodiment of the invention have been illustrated herein by specific examples, and the description of the above embodiment is only applicable to helping understand the principles of an embodiment of the invention. Meanwhile, those of ordinary skill in the art can make changes in terms of particular embodiments and application scopes based on an embodiment of the invention. In summary, the contents of the description should not be interpreted as limiting the invention.

1. Electric pruning scissors comprising a shear body, wherein,
a movable blade and a fixed blade in movable connection are arranged at a front end of the shear body;
a tail end of the shear body is connected with a housing;
the housing is internally provided with a driving device for driving the movable blade to operate;
a trigger is arranged at the bottom of the housing;
the driving device comprises a motor, an epicyclic gearbox, a screw, a bearing and a power supply;
one end of the motor is electrically connected with the power supply and the other end of the motor drives the epicyclic gearbox;
one end of the epicyclic gearbox is connected with the bearing by a bearing fixing ring;
one end of the bearing is connected with the screw;
one end of the screw is connected with a guide tube by a feed screw nut;
the guide tube is externally sleeved with a casting; and
one end of the casting that is close to the movable blade is connected with a guide rod.

2. The electric pruning scissors according to claim 1, wherein,
the epicyclic gearbox comprises a motor gear, a planetary gear, an internal gear ring, a gear carrier and a gear ring sleeve;
a spacer is arranged between the motor gear and the planetary gear;
the planetary gear is fixed on a raised cylinder of the gear carrier and clamped into the internal gear ring; and
the internal gear ring is located in the gear ring sleeve and the bearing fixing ring is arranged at an end of the gear ring sleeve.

3. The electric pruning scissors according to claim 1, wherein,
the housing comprises a left side body and a right side body; and
the left side body and the right side body are buckled together to form a hollow sealed whole body, a front end of which is provided with openings where the movable blade and the fixed blade are mounted.

4. The electric pruning scissors according to claim 3, wherein,
a trigger is arranged at the bottom of the housing;
the trigger is connected with a circuit switchboard; and
the circuit switchboard is connected with a circuit board for controlling an on-off state of the power supply and the rotation direction of the epicyclic gearbox by a magnet.

5. The electric pruning scissors according to claim 1, wherein,
the housing is also internally provided with an overload protection chip.

6. The electric pruning scissors according to claim 1, wherein,
joints between the housing and the movable blade and between the housing and the fixed blade are respectively provided with a silica gel dust-proof pad.
